(19) United States
(12) Patent Application Publication
(10) Pub. No.: US 2016/0337565 A1
(43) Pub. Date: Nov. 17, 2016

(54) IMAGE GENERATION METHOD AND APPARATUS, AND TERMINAL DEVICE

(71) Applicant: Wen Hua LONG, Beijing (CN)

(72) Inventor: Wen Hua LONG, Beijing (CN)

(21) Appl. No.: 14/769,165

(22) PCT Filed: May 13, 2015
(86) PCT No.: PCT/IB2015/053540

§ 371 Date: Mar. 16, 2016

(51) Int. Cl. H04N 5/225; G03B 15/05; H04N 5/235

(52) U.S. Cl. CPC H04N 5/2256; H04N 5/2354; G03B 15/05; G03B 2215/0567; G03B 2215/0571; G03B 2215/0503

(57) ABSTRACT

The present disclosure provides an image generation method and apparatus, and a terminal device. The image generation method includes the steps of: obtaining an environmental color temperature; adjusting proportions of light intensities of a first flash lamp (LED A), a second flash lamp (LED B) and a third flash lamp (LED C) to obtain a first mixed light after the adjustment, so that a chromaticity coordinate of the first mixed light (Mix 1) is located on a planckian locus, and a color temperature of the first mixed light is equal to the environmental color temperature; taking the first mixed light as flash lamp light to generate an image. Through the embodiments of the present disclosure, the color temperature of the flash lamp is matched with the environmental color temperature, and it is beneficial for the mobile terminal to perform an automatic white balance processing, thereby improving the quality of the generated image, and providing the user with better experiences.

### CROSS-REFERENCE TO RELATED APPLICATION AND PRIORITY CLAIM

This application claims the benefit of Chinese Patent Application Serial No. 201410645503.4, filed Nov. 11, 2014, the entire disclosure of which is hereby incorporated by reference.

### TECHNICAL FIELD

The present disclosure relates to mobile communication technologies, and particularly, to an image generation method and apparatus, and a terminal device.

### BACKGROUND

With the development of technologies, more and more terminal devices have a shooting function. Currently, terminal devices having the shooting function include mobile terminals for communication (cellular phone), cameras, tablet PCs, wearable devices, etc. A user can shoot an image or a video at any time through shooting members provided in those terminal devices.

To be noted, the above introduction to the technical background is just made for the convenience of clearly and completely describing the technical solutions of the present disclosure, and to facilitate the understanding by a person skilled in the art. It shall not be deemed that the above technical solutions are known to a person skilled in the art just because they have been illustrated in the Background section of the disclosure.

### SUMMARY

However, the inventor has found that when the terminal device shoots an image with a flash lamp, the color of the flash lamp may not be matched with the color of the environment due to a diversity of the shooting environment if a single flash lamp (e.g., an LED flash lamp) is used, and then a satisfactory image cannot be shot.

Under the circumstance that double LED flash lamps are used, although the color of a mixed light of the two LED flash lamps can be adjusted by adjusting proportions of light intensities of those flash lamps so as to match the environmental color, the color of the mixed light of the two LED flash lamps is located at a line segment formed by the chromaticity coordinates of the lights of the two LED flash lamps in the color space, hardly on a planckian locus. Thus, the terminal device has more difficulty in performing an automatic white balance processing, and it is also difficult to obtain a satisfactory image.

The embodiments of the present disclosure provide an image generation method and apparatus and a terminal device. By using three flash lamps and adjusting proportions of their light intensities, a flash lamp light having its color temperature matched with the environmental color temperature and being located on the planckian locus is obtained. Thus, it is beneficial to perform an automatic white balance processing, thereby improving the quality of the generated images, and providing the user with better experiences.

According to a first aspect of the embodiment of the present disclosure, an image generation method is provided, including:

obtaining an environmental color temperature;

adjusting proportions of light intensities of a first flash lamp, a second flash lamp and a third flash lamp to obtain a first mixed light after the adjustment, so that a chromaticity coordinate of the first mixed light is located on a planckian locus, and a color temperature of the first mixed light is equal to the environmental color temperature;

taking the first mixed light as flash lamp light to generate an image.

According to a second aspect of the embodiment of the present disclosure, a region formed by the chromaticity coordinates of the lights of the first flash lamp, the second flash lamp and the third flash lamp includes a part of the planckian locus.

According to a third aspect of the embodiment of the present disclosure, adjusting proportions of light intensities of a first flash lamp, a second flash lamp and a third flash lamp to obtain a first mixed light after the adjustment, so that a chromaticity coordinate of the first mixed light is located on a planckian locus, and a color temperature of the first mixed light is equal to the environmental color temperature includes:

adjusting the proportions of light intensities of the first flash lamp and the second flash lamp to obtain a second mixed light;

adjusting the proportions of light intensities of the second mixed light and the third flash lamp to obtain the first mixed light having the chromaticity coordinate located on the planckian locus and the color temperature equals to the environmental color temperature.

According to a fourth aspect of the embodiment of the present disclosure, taking the first mixed light as flash lamp light to generate an image includes:

taking the first mixed light as flash lamp light to generate an image to be processed; and further including

performing an automatic white balance processing of the image to be processed to generate the image.

According to a fifth aspect of the embodiment of the present disclosure, the first flash lamp, the second flash lamp and the third flash lamp are Light Emitting Diode (LED) flash lamps.

According to a sixth aspect of the embodiment of the present disclosure, an image generation apparatus is provided, including:

an environmental color temperature detection unit (the term “unit” may also be referred to and understood throughout this application as “module”) configured to obtain an environmental color temperature;

a light proportion adjustment unit configured to adjust proportions of light intensities of a first flash lamp, a second flash lamp and a third flash lamp to obtain a first mixed light after the adjustment, so that a chromaticity coordinate of the first mixed light is located on a planckian locus, and a color temperature of the first mixed light is equal to the environmental color temperature; and

an image generation unit configured to take the first mixed light as flash lamp light to generate an image.

According to a seventh aspect of the embodiment of the present disclosure, a region formed by the chromaticity coordinates of the lights of the first flash lamp, the second flash lamp and the third flash lamp includes a part of the planckian locus.

According to an eighth aspect of the embodiment of the present disclosure, the light proportion adjustment unit is configured to adjust the proportions of light intensities of the first flash lamp and the second flash lamp to obtain a second mixed light; and to adjust the proportions of light intensities of the second mixed light and the third flash lamp to obtain the first mixed light.

According to a ninth aspect of the embodiment of the present disclosure, the image generation unit specifically includes:

a to-be-processed image generation unit configured to take the first mixed light as flash lamp light to generate an image to be processed; and

an image processing unit configured to perform an automatic white balance processing of the image to be processed to generate the image.

According to a tenth aspect of the embodiment of the present disclosure, a terminal device is provided, at least having a camera, a first flash lamp, a second flash lamp and a third flash lamp; the terminal device further includes the above image generation apparatus.

According to an eleventh aspect of the embodiment of the present disclosure, the first flash lamp, the second flash lamp and the third flash lamp are Light Emitting Diode (LED) flash lamps.

The embodiments of the present disclosure have the following beneficial effect: the proportions of light intensities of at least three flash lamps are adjusted to obtain a first mixed light after the adjustment, so that the chromaticity coordinate of the first mixed light is located on the planckian locus, and a color temperature of the first mixed light is equal to the environmental color temperature. Thus, the color temperature of the flash lamp is matched with the environmental color temperature, and it is beneficial for the mobile terminal to perform an automatic white balance processing, thereby improving the quality of the generated image, and providing the user with better experiences.

These and other aspects of the present disclosure will be clear with reference to the subsequent descriptions and drawings, which disclose the particular embodiments of the present invention to indicate some implementations of the principle of the present disclosure. But it shall be appreciated that the scope of the present disclosure is not limited thereto. On the contrary, the present invention includes all the changes, modifications and equivalents falling within the scope of the spirit and the connotations of the accompanied claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

Many aspects of the present disclosure will be understood better with reference to the following drawings. The components in the drawings are not surely drafted in proportion, and the emphasis lies in clearly illustrating principles of the present disclosure. For the convenience of illustrating and describing some portions of the present disclosure, corresponding portions in the drawings may be enlarged, e.g., being more enlarged relative to other portions than the situation in the exemplary device practically manufactured according to the present disclosure. The parts and features illustrated in one drawing or embodiment of the present disclosure may be combined with the parts and features illustrated in one or more other drawings or embodiments. In addition, the same reference signs denote corresponding portions throughout the drawings, and they can be used to denote the same or similar portions in more than one embodiment.

### BRIEF DESCRIPTION OF THE DRAWINGS

The accompanying drawings are included to provide further understanding of the present disclosure, and they constitute a part of the Specification. Those drawings illustrate the preferred embodiments of the present disclosure, and explain the principle of the present disclosure together with the descriptions, wherein the same element is always denoted with the same reference sign.

In which,

FIG. 1 is a flow diagram of an image generation method according to an embodiment of the present disclosure;

FIG. 2 is a schematic diagram of an adjustment of proportions of lights of LED flash lamps in an image generation method according to an embodiment of the present disclosure;

FIG. 3 is a schematic diagram of mounting positions of three LED flash lamps in an image generation method according to an embodiment of the present disclosure;

FIG. 4 is another flow diagram of an image generation method according to an embodiment of the present disclosure;

FIG. 5 is a structure diagram of an image generation apparatus according to an embodiment of the present disclosure;

FIG. 6 is a structure diagram of a terminal device according to an embodiment of the present disclosure; and

FIG. 7 is a block diagram of a system construction of a mobile terminal according to an embodiment of the present disclosure.

### DESCRIPTION OF THE EMBODIMENTS

The interchangeable terms “electronic device” and “electronic apparatus” include a portable radio communication device. The term “portable radio communication device”, which may be hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc.

In the present application, the embodiments of the present disclosure are mainly described with respect to a portable electronic apparatus in the form of a mobile phone (also referred to as “cellular phone”). However, it shall be appreciated that the present disclosure is not limited to the case of the mobile phone and it may relate to any type of appropriate electronic device, such as media player, gaming device, PDA and computer, digital video camera, tablet PC, wearable electronic device, etc.

### Embodiment 1

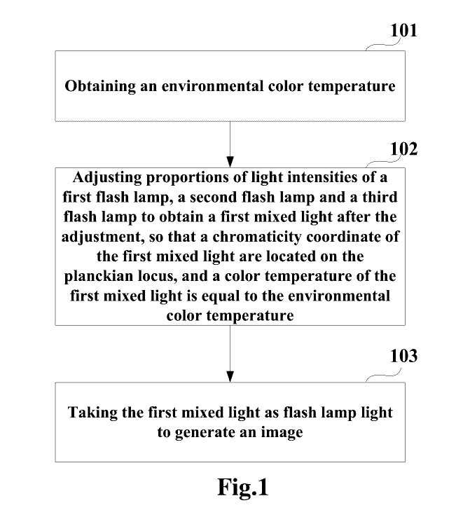

The embodiment of the present disclosure provides an image generation method. FIG. 1 is a flow diagram of an image generation method according to an embodiment of the present disclosure.

As illustrated in FIG. 1, the image generation method includes:

step 101: obtaining an environmental color temperature;

step 102: adjusting proportions of light intensities of a first flash lamp, a second flash lamp and a third flash lamp to obtain a first mixed light after the adjustment, so that a chromaticity coordinate of the first mixed light is located on a planckian locus, and a color temperature of the first mixed light is equal to the environmental color temperature;

step 103: taking the first mixed light as flash lamp light to generate an image.

In this embodiment, the image generation method can be applied to a terminal device such as, but not limited to, a mobile terminal for communication (cellular phone), a camera, a smart phone, a tablet PC or a wearable device. The following descriptions take the mobile terminal as an example.

In step 101, the mobile terminal may detect environmental light to obtain the environmental color temperature. For example, the mobile terminal may be provided with a color temperature measuring instrument by using which the current environmental light may be detected to obtain the environmental color temperature of the current environment surrounding the mobile terminal. For example, the environmental color temperature may be 4000 K.

In step 102, the method for adjusting the proportions of light intensities of the flash lamps specifically may include: adjusting the proportions of light intensities of the first flash lamp, the second flash lamp and the third flash lamp to obtain the first mixed light after the adjustment, so that the chromaticity coordinate of the first mixed light is located on the planckian locus, and the color temperature of the first mixed light is equal to the environmental color temperature.

For example, the planckian locus is a locus of points representing chromaticity of a planckian radiator (also referred to as black body) in different temperatures in a chromaticity diagram. In addition, the chromaticity coordinate and/or the color temperature of the first mixed light can be changed by adjusting the proportions of light intensities of the first flash lamp, the second flash lamp and the third flash lamp.

In this embodiment, a person skilled in the art can understand that the chromaticity coordinate of the first mixed light needs not to be always located on the planckian locus accurately. For example, due to the restriction of the manufacturing technology, the chromaticity coordinate of the first mixed light can slightly deviate from the planckian locus, and this situation shall also fall within the protection scope of the present disclosure. And the color temperature of the first mixed light and the environmental color temperature also need not to be equal to each other accurately; they can be approximately equal to each other due to, for example, the restriction of the manufacturing technology. For example, when the environmental color temperature is 5000 K while the color temperature of the first mixed light is 4998 K, they may be deemed as being equal to each other. Those situations are not limited in the embodiment of the present disclosure.

For example, regarding the manufacturing technology in the art, when the distance between the chromaticity coordinate and the planckian locus is less than a predetermined value (which may be obtained from experiences), it may be deemed that the chromaticity coordinate is located on the planckian locus. Alternatively, regarding the manufacturing technology in the art, when the difference between the color temperature of the first mixed light and the environmental color temperature is less than another predetermined value (e.g., 50 K), it may be deemed that these two color temperatures are equal to each other. A person skilled in the art can determine the specific tolerable error according to the actual manufacturing technology or the actual demand, which is not limited herein.

In this embodiment, the chromaticity coordinate of the mixed light cannot be absolutely accurately located on the planckian locus due to technical limitation, which is well known by those skilled in the art. The reasons for the deviation may include: the individual difference of the flash lamp caused by the process of manufacturing, the flash lamp efficiency is attenuated when the temperature rises, the output of the driver chip of the flash lamp is deviated, the color temperature measuring unit has a deviation, etc. (As is mentioned above, the term “unit” may also be referred to and understood throughout this application as “module.”)

Moreover, in the embodiment of the present disclosure, the number of the flash lamps may be, but not limited to, at least three, and four or more flash lamps may be available and used. Herein the descriptions are exemplarily made with three flash lamps.

In this embodiment, by adjusting at least three flash lamps and considering the influence of the environmental light, the chromaticity coordinate of the mixed light is located on the planckian locus, and the color temperature of the mixed light is equal to the environmental color temperature; thus, a better image quality is achieved. From another perspective, it may be deemed that the environmental light is mixed with the light of at least three flash lamps.

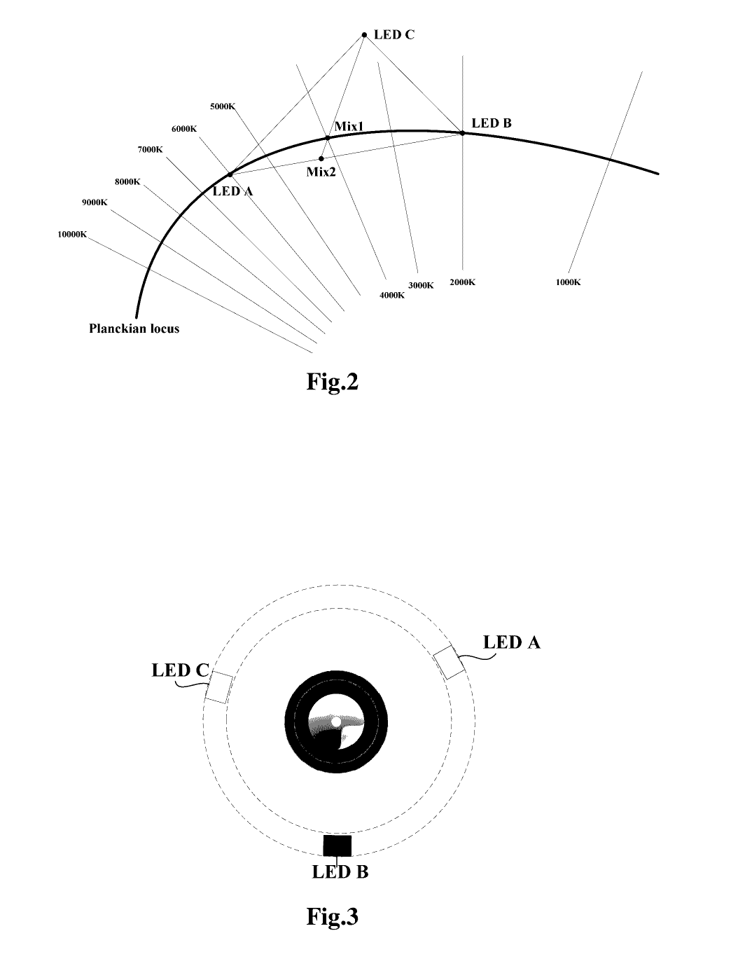

FIG. 2 is a schematic diagram of an adjustment of proportions of light intensities of flash lamps in an image generation method according to an embodiment of the present disclosure. FIG. 2 illustrates by taking the Light Emitting Diode (LED) flash lamps as an example, but the present disclosure is not limited thereto.

As illustrated in FIG. 2, in the chromaticity diagram, for example the environmental color temperature is 4000 K. Firstly, proportions of light intensities of flash lamps LED A and LED B of the chromaticity coordinates located on the planckian locus are adjusted to obtain a mixed light Mix2 (second mixed light); the chromaticity coordinate of Mix2 is located in the color space and on a line segment connecting the chromaticity coordinates of the lights of LED A and LED B. Next, the proportion of the light intensity of LED C is adjusted to obtain a mixed light Mix1 (first mixed light); the chromaticity coordinate of Mix1 is located in the color space and on a line segment connecting the chromaticity coordinates of the lights of Mix2 and LED C. In the embodiment, as illustrated in FIG. 2, the chromaticity coordinate of the light of Mix1 is located on the planckian locus, and the color temperature of Mix1 is equal to the environmental color temperature, both being 4000 K.

The embodiment of the present disclosure is described through an example in which the proportions of light intensities of LED A and LED B are adjusted to obtain a mixed light Mix2, and then the proportion of light intensity of LED C is adjusted to obtain a mixed light Mix1. But the present disclosure is not limited thereto. For example, the adjustment may be firstly made for LED A and LED C, or for LED B and LED C, or for LED A, LED B and LED C at the same time, provided that the obtained mixed light Mix1 meets the requirement.

Through this embodiment, the chromaticity coordinate of the mixed light Mix1 is located on the planckian locus, and the color temperature of the mixed light Mix1 is equal to the environmental color temperature. Thus, it is beneficial for the mobile terminal to perform an automatic white balance processing, thereby improving the quality of the generated image, and providing the user with better experiences.

In this embodiment, as illustrated in FIG. 2, the chromaticity coordinates of the lights of LED A and LED B are located at different points on the planckian locus, and the chromaticity coordinate of the light of LED C is located at one side of the curved protuberance of the planckian locus, so that a region formed by the chromaticity coordinates of the lights of LED A, LED B and LED C includes a part of the planckian locus.

But the embodiment of the present disclosure is not limited thereto. For example, just the chromaticity coordinate of the light of LED A is located on the planckian locus, or none of the chromaticity coordinates of the lights of the three LEDs is located on the planckian locus, and it is only required that the region formed by the chromaticity coordinates of the lights of LED A, LED B and LED C includes a part of the planckian locus. By appropriate adjustment, the chromaticity coordinate of the mixed light formed by LED A, LED B and LED C is located on the planckian locus within a region (a triangular region) formed by the chromaticity coordinates of the lights of LED A, LED B and LED C, and the range of the color temperature of the mixed light is between the maximum value and the minimum value of the color temperature of the part of the planckian locus.

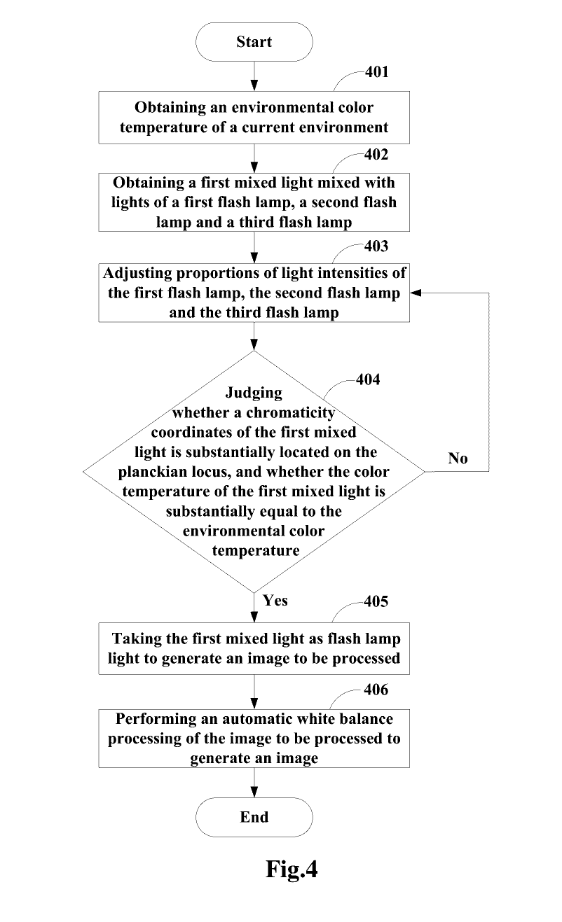

FIG. 3 is a schematic diagram of mounting positions of three flash lamps in an image generation method according to an embodiment of the present disclosure. As illustrated in FIG. 3, flash lamps LED A, LED B and LED C are provided around the camera of the mobile terminal, respectively. Specifically, the three flash lamps may be uniformly provided on a circumference centering at the camera, or placed together near the camera. But the embodiment of the present invention is not limited thereto, and the positions of the three flash lamps may be other situations.

To be noted, in this embodiment, the LED flash lamp is taken as an example, while the present invention is not limited thereto. For example, electronic flash lamp may also be used. In addition, the three flash lamps are not necessarily mounted around the camera. For example, those flash lamps may be separated from the camera as three independent flash devices, and synchronized by using a radio trigger.

In this embodiment, the camera may be provided in a mobile terminal, such as being a front-facing camera of a smart phone, or removably integrated with the mobile terminal through an interface. In addition, the camera may be connected to the mobile terminal in a wired or wireless way, such as being controlled by the mobile terminal through WiFi. The present disclosure is not limited thereto, and the mobile terminal may be connected to the camera in other ways.

In step 103, taking the first mixed light as flash lamp light to generate an image includes: taking the first mixed light as flash lamp light to generate an image to be processed, and performing an Automatic White Balance (AWB) processing of the image to be processed to generate the image.

For example, an image to be processed of better quality can be obtained by shooting with the first mixed light matching the environmental color temperature as the flash lamp light. In addition, since the chromaticity coordinate of the first mixed light is located on the planckian locus, it is beneficial for the mobile terminal to perform an automatic white balance processing, thereby improving the quality of the generated image, and providing the user with better experiences.

For example, the mobile terminal obtains an image to be processed by shooting by using the camera with the mixed light Mix1 obtained in step 102 as flash lamp light. Herein the image to be processed is an image not undergoing an automatic white balance processing. Next, the mobile terminal performs an automatic white balance processing of the image to be processed by taking Mix1 as a reference color to obtain a processed image.

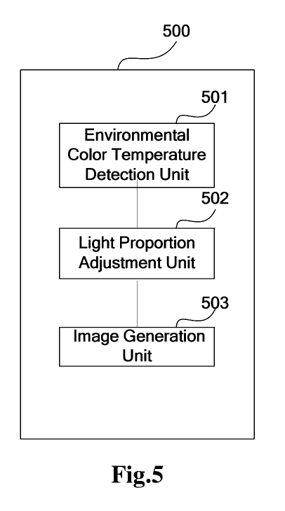

FIG. 4 is another flow diagram of an image generation method according to an embodiment of the present disclosure. As illustrated in FIG. 4, the image generation method includes:

step 401: obtaining an environmental color temperature of a current environment;

step 402: obtaining a first mixed light mixed with lights of a first flash lamp, a second flash lamp and a third flash lamp;

step 403: adjusting proportions of light intensities of the first flash lamp, the second flash lamp and the third flash lamp;

in which, the chromaticity coordinate and/or the color temperature of the first mixed light can be changed by adjusting the proportions of light intensities of the first flash lamp, the second flash lamp and the third flash lamp;

step 404: judging whether the chromaticity coordinate of the first mixed light is substantially located on the planckian locus, and whether the color temperature of the first mixed light is substantially equal to the environmental color temperature; if yes, performing step 405, otherwise performing step 403;

step 405: taking the first mixed light as flash lamp light to generate an image to be processed;

step 406: performing an automatic white balance processing of the image to be processed to generate an image.

As can be seen from the above embodiment, the proportions of light intensities of the first flash lamp, the second flash lamp and the third flash lamp are adjusted to obtain a first mixed light after the adjustment, so that the chromaticity coordinate of the first mixed light is located on the planckian locus, and a color temperature of the first mixed light is equal to the environmental color temperature. Thus, the color temperature of the flash lamp is matched with the environmental color temperature, and it is beneficial for the mobile terminal to perform an automatic white balance processing, thereby improving the quality of the generated image, and providing the user with better experiences.

### Embodiment 2

Embodiment 2 of the present invention provides an image generation apparatus provided in a mobile terminal. This embodiment is corresponding to the image generation method of Embodiment 1, and the same contents are omitted herein.

FIG. 5 is a structure diagram of an image generation apparatus according to an embodiment of the present disclosure. As illustrated in FIG. 5, an image generation apparatus 500 includes an environmental color temperature detection unit 501, a light proportion adjustment unit 502 and an image generation unit 503.

The environmental color temperature detection unit 501 obtains an environmental color temperature. The light proportion adjustment unit 502 adjusts proportions of light intensities of a first flash lamp, a second flash lamp and a third flash lamp to obtain a first mixed light after the adjustment, so that the chromaticity coordinate of the first mixed light is located on the planckian locus, and a color temperature of the first mixed light is equal to the environmental color temperature. The image generation unit 503 takes the first mixed light as flash lamp light to generate an image.

In this embodiment, the light proportion adjustment unit 502 may be configured to adjust the proportions of light intensities of the first flash lamp and the second flash lamp to obtain a second mixed light; and adjust the proportions of the second mixed light and the light of the third flash lamp to obtain the first mixed light.

In this embodiment, the image generation unit 503 may include: a to-be-processed image generation unit configured to take the first mixed light as flash lamp light to generate an image to be processed; and an image processing unit configured to perform an automatic white balance processing of the image to be processed to generate the image.

As can be seen from the above embodiment, the proportions of light intensities of the first flash lamp, the second flash lamp and the third flash lamp are adjusted to obtain a first mixed light after the adjustment, so that the chromaticity coordinate of the first mixed light is located on the planckian locus, and a color temperature of the first mixed light is equal to the environmental color temperature. Thus, the color temperature of the flash lamp is matched with the environmental color temperature, and it is beneficial for the mobile terminal to perform an automatic white balance processing, thereby improving the quality of the generated image, and providing the user with better experiences.

### Embodiment 3

Embodiment 3 of the present disclosure provides a terminal device at least having a camera, a first flash lamp, a second flash lamp and a third flash lamp. The terminal device further includes the image generation apparatus of Embodiment 2, the content of which is incorporated herein and not repeated.

For example, the terminal device may be a mobile terminal for communication (cellular phone), a photo camera, a video camera, a tablet PC, a wearable device, etc., but the present disclosure is not limited thereto.

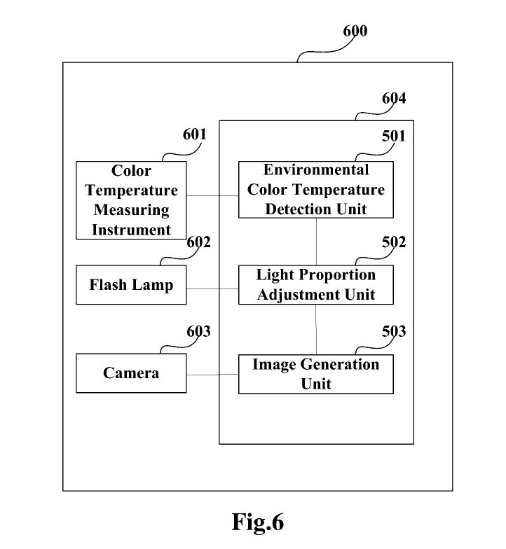

FIG. 6 is a structure diagram of a terminal device according to an embodiment of the present disclosure, which illustrates an example of a terminal device 600. For the purpose of briefness, FIG. 6 only illustrates the parts related to the embodiment of the present disclosure, while other parts of the terminal device 600 are not illustrated.

As illustrated in FIG. 6, the terminal device 600 may include a color temperature measuring instrument 601, a flash lamp 602, a camera 603 and a controller 604. The functions of the image generation apparatus 500 of Embodiment 2 can be integrated into the controller 604. The flash lamps 602 at least include a first flash lamp, a second flash lamp and a third flash lamp. The controller 604 may perform the image generation method of Embodiment 1.

Next, the terminal device of the present disclosure will be further described by taking the mobile communication terminal as an example.

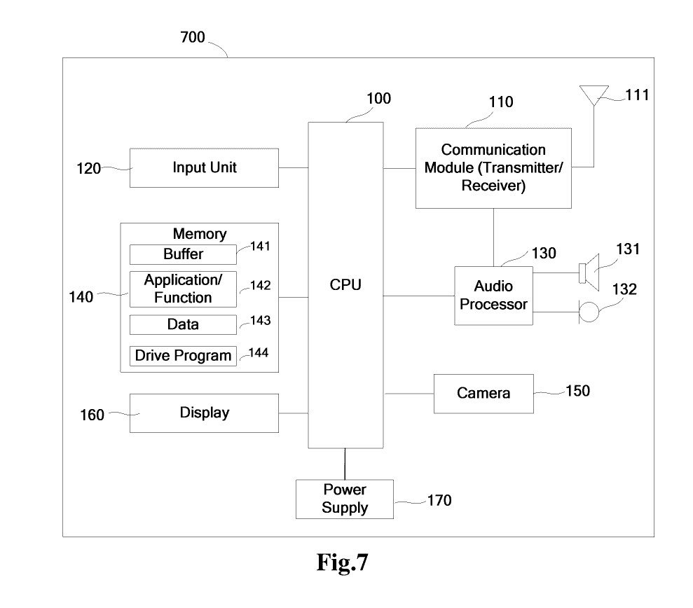

FIG. 7 is a block diagram of a system construction of a mobile terminal according to an embodiment of the present disclosure. A mobile terminal 700 may include a Central Processing Unit (CPU) 100 and a memory 140 coupled thereto. To be noted, the diagram is exemplary, and other type of structure may be used to supplement or replace the structure, so as to realize the telecom function or other function.

As illustrated in FIG. 7, the mobile terminal 700 may further include a camera 150 (image acquiring part) and an input unit 120 (information input part). For the purpose of briefness, FIG. 7 does not illustrate the color temperature measuring instrument, e.g., 601 in FIG. 6, or the flash lamp, e.g., 602 in FIG. 6.

In one implementation, the functions of the image generation apparatus 500 may be integrated into the CPU 100, wherein the CPU 100 may be configured to perform the image generation method of Embodiment 1.

In another implementation, the image generation apparatus 500 may be provided in separation from the CPU 100. For example, the image generation apparatus 500 may be provided as a chip connected to the CPU 100, and the functions of the image generation apparatus 500 are realized under the control of the CPU 100.

As illustrated in FIG. 7, the mobile terminal 700 may include a communication module 110, an audio processor 130, a display 160 and a power supply 170. To be noted, the mobile terminal 700 is unnecessary to include all the parts as illustrated in FIG. 7. In addition, the mobile terminal 700 may also include parts not illustrated in FIG. 7, and please refer to the relevant art.

As illustrated in FIG. 7, the CPU 100 sometimes is called as controller or operation control, and it may include a microprocessor or other processor device and logic device and may be the same as or part of the controller 604 referred illustrated in FIG. 6. The CPU 100 receives an input and controls the operations on respective parts of the mobile terminal 700.

The memory 140, for example, may be one or more of buffer, flash memory, hard drive, removable media, volatile memory, nonvolatile memory or other appropriate device. The memory 140 may store the data or information, such as image data, operational information or data, such as planckian information, and a program for executing related information or computer code, and so on. In addition, the CPU 100 may execute the program stored in the memory 140 for information storage or processing.

The input unit 120 provides an input to the CPU 100. The input unit 120 for example is a key or a touch input device. The camera 150 captures image data and supplies the captured image data to the CPU 100 for a conventional usage, such as storage, transmission, etc. The power supply 170 supplies electric power to the mobile terminal 700. The display 160 displays objects such as images and texts. The display may be, but not limited to, an LCD

The memory 140 may be a solid state memory, such as Read Only Memory (ROM), Random Access Memory (RAM), SIM card, etc., or a memory which stores information even if the power is off, which can be selectively erased and provided with more data, and the example of such a memory is sometimes called an EPROM, etc. The memory 140 also may be a certain device of other type. The memory 140 includes a buffer memory 141 (sometimes called as buffer). The memory 140 may include an application/function storage section 142 which stores application programs and function programs or performs the operation procedure of the mobile terminal 1400 via the CPU 100.

The memory 140 may further include a data storage section 143 which stores data such as contacts, digital data, pictures, sounds and/or any other data used by the electronic device. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of the conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via an audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The embodiment of the present disclosure further provides a computer readable program, which when being executed in a mobile terminal, enables a computer to perform the image generation method of Embodiment 1 in the terminal device.

The embodiment of the present disclosure further provides a storage medium storing a computer readable program, wherein the computer readable program enables a computer to perform the image generation method of Embodiment 1 in a terminal device.

The preferred embodiments of the present disclosure are described as above with reference to the drawings. Many features and advantages of those embodiments are apparent from the detailed Specification, thus the accompanied claims intend to cover all the features and advantages of those embodiments which fall within the spirit and scope thereof. In addition, since numerous modifications and changes are easily conceivable to a person skilled in the art, the embodiments of the present disclosure are not limited to the exact structures and operations as illustrated and described, but cover all suitable modifications and equivalents falling within the scope thereof.

It shall be understood that each part of the present disclosure may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of comprising one or more modules, segments or parts for realizing the codes of executable instructions of the steps in specific logic functions or processes, and that the scope of the preferred embodiments of the present disclosure include other implementations, wherein the functions may be executed in manners different from those shown or discussed (e.g., according to the related functions in a substantially simultaneous manner or in a reverse order), which shall be understood by a person skilled in the art.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present disclosure. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present disclosure by using the apparatus.

Particular embodiments of the present disclosure have been disclosed herein. A person skilled in the art will readily recognize that the present disclosure is applicable in other environments. In practice, there exist many embodiments and implementations. The appended claims are by no means intended to limit the scope of the present disclosure to the above particular embodiments.

Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present disclosure has been described, it is obvious that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present disclosure with respect to structure. Furthermore, although the a particular feature of the present disclosure is described with respect to only one or more of the illustrated embodiments, such a feature may be combined with one or more other features of other embodiments as desired and in consideration of advantageous aspects of any given or particular application.

1. An image generation method, comprising:
obtaining an environmental color temperature;
adjusting proportions of light intensities of a first flash lamp, a second flash lamp and a third flash lamp to obtain a first mixed light after the adjustment, so that a chromaticity coordinate of the first mixed light is located on a planckian locus, and a color temperature of the first mixed light is equal to the environmental color temperature;
taking the first mixed light as flash lamp light to generate an image.

2. The image generation method according to claim 1, wherein a region formed by the chromaticity coordinates of the lights of the first flash lamp, the second flash lamp and the third flash lamp includes a part of the planckian locus.

3. The image generation method according to claim 1, wherein adjusting proportions of light intensities of a first flash lamp, a second flash lamp and a third flash lamp to obtain a first mixed light after the adjustment, so that a chromaticity coordinate of the first mixed light is located on a planckian locus, and a color temperature of the first mixed light is equal to the environmental color temperature comprises:
adjusting the proportions of light intensities of the first flash lamp and the second flash lamp to obtain a second mixed light;
adjusting the proportions of light intensities of the second mixed light and the third flash lamp to obtain the first mixed light having the chromaticity coordinate located on the planckian locus and the color temperature equals to the environmental color temperature.

4. The image generation method according to claim 1, wherein taking the first mixed light as flash lamp light to generate an image comprises:
taking the first mixed light as flash lamp light to generate an image to be processed; and further comprising
performing an automatic white balance processing of the image to be processed to generate the image.

5. The image generation method according to claim 1, wherein the first flash lamp, the second flash lamp and the third flash lamp are Light Emitting Diode (LED) flash lamps.

6. An image generation apparatus, comprising:
an environmental color temperature detection unit configured to obtain an environmental color temperature;
a light proportion adjustment unit configured to adjust proportions of light intensities of a first flash lamp, a second flash lamp and a third flash lamp to obtain a first mixed light after the adjustment, so that the chromaticity coordinate of the first mixed light is located on the planckian locus, and a color temperature of the first mixed light is equal to the environmental color temperature; and
an image generation unit configured to take the first mixed light as flash lamp light to generate an image.

7. The image generation apparatus according to claim 6, wherein a region formed by the chromaticity coordinates of the lights of the first flash lamp, the second flash lamp and the third flash lamp includes a part of the planckian locus.

8. The image generation apparatus according to claim 6, wherein the light proportion adjustment unit is specifically configured to adjust the proportions of light intensities of the first flash lamp and the second flash lamp to obtain a second mixed light; and adjust the proportions of light intensities of the second mixed light and the third flash lamp to obtain the first mixed light.

9. The image generation apparatus according to claim 6, wherein the image generation unit comprises:
a to-be-processed image generation unit configured to take the first mixed light as flash lamp light to generate an image to be processed; and
an image processing unit configured to perform an automatic white balance processing of the image to be processed to generate the image.

10. A terminal device at least having a camera, a first flash lamp, a second flash lamp and a third flash lamp; the terminal device further comprises the image generation apparatus according to claim 6.

11. The terminal device according to claim 10, wherein the first flash lamp, the second flash lamp and the third flash lamp are Light Emitting Diode (LED) flash lamps.

12. A terminal device at least having a camera, a first flash lamp, a second flash lamp and a third flash lamp; the terminal device further comprises the image generation apparatus according to claim 7.

13. The terminal device according to claim 12, wherein the first flash lamp, the second flash lamp and the third flash lamp are Light Emitting Diode (LED) flash lamps.

14. A terminal device at least having a camera, a first flash lamp, a second flash lamp and a third flash lamp; the terminal device further comprises the image generation apparatus according to claim 8.

15. The terminal device according to claim 14, wherein the first flash lamp, the second flash lamp and the third flash lamp are Light Emitting Diode (LED) flash lamps.

16. A terminal device at least having a camera, a first flash lamp, a second flash lamp and a third flash lamp; the terminal device further comprises the image generation apparatus according to claim 9.

17. The terminal device according to claim 16, wherein the first flash lamp, the second flash lamp and the third flash lamp are Light Emitting Diode (LED) flash lamps.
